(19) United States
(12) Patent Application Publication
(10) Pub. No.: US 2004/0126168 A1
(43) Pub. Date: Jul. 1, 2004

(54) Laser printer and image forming apparatus

(75) Inventor: Masayuki Fujimoto, Daito-shi (JP)

Correspondence Address: CROWELL & MORING LLP, INTELLECTUAL PROPERTY GROUP, P.O. BOX 14300, WASHINGTON, DC, 20044-4300, US

(73) Assignee: Funai Electric Co., Ltd.

(21) Appl. No.: 10/688,947

(22) Filed: Oct. 21, 2003

(30) Foreign Application Priority Data
Oct. 21, 2002 (JP) P2002-305344

(51) Int. Cl. B41J 2/00

(52) U.S. Cl. 400/118.2

(57) ABSTRACT

A laser printer has one circuit board made of paper phenol without heat radiation function and provided outside a frame body, in which two circuits of a semiconductor laser drive circuit and a motor drive circuit are packaged, a motor mounting member having a motor mounting function alone, a flexible cable for connecting the circuit board provided outside the frame body with a motor placed inside the frame body, and a flexible cable for connecting the circuit board provided outside the frame body with a semiconductor laser installed inside the frame body to be angularly adjustable by itself.

### BACKGROUND OF THE INVENTION

1. Field of the Invention

The present invention relates to an image forming apparatus such as a laser printer, and more particularly to an image forming apparatus such as a laser printer provided with a laser scanning unit having a plurality of circuits.

2. Description of the Related Art

Conventionally, an image forming apparatus provided with a laser scanning unit having a plurality of circuits including a motor drive circuit and a semiconductor laser drive circuit has been well known. In the following description, a laser printer will be dealt with as an example of the image forming apparatus provided with the laser scanning unit having a plurality of circuits.

FIG. 5 is a perspective view showing a conventional laser printer. FIG. 6 is a plan view showing an internal structure of a laser scanning unit in the conventional laser printer as shown in FIG. 5. Referring now to FIGS. 5 and 6, the structure of the conventional laser printer will be described.

The conventional laser printer 100 has a toner cartridge 120 and a laser scanning unit 101 placed above the toner cartridge 120, as shown in FIG. 5. The toner cartridge 120 is provided with a photosensitive drum (not shown) for transferring toner onto a paper and a toner tank portion (not shown) filled with toner. The laser scanning unit 101 has various parts to form an electronic image on the photosensitive drum.

More specifically, an iron circuit board 121 having a heat radiation function with a motor drive circuit (not shown) packaged is mounted inside a convex portion 102a provided on a frame body 102, as shown in FIG. 6. A motor 104 is mounted on this iron circuit board 121. Heat produced by driving the motor 104 is radiated by the iron circuit board 121 having the heat radiation function. Thereby, the motor drive circuit is protected from breakage due to heat. Also, a polygon mirror 105 for causing a laser beam 106b to scan on the photosensitive drum by reflecting a laser beam 106a while rotating is mounted at a rotation shaft (not shown) of the motor 104. A circuit board 122 with a semiconductor laser drive circuit (not shown) packaged is mounted in a predetermined area inside the frame body 102. In this circuit 122, a semiconductor laser 106 is attached to be able to emit the laser beam 106a in a direction toward the polygon mirror 105.

Also, a mirror 112 for reflecting a laser beam 106b reflected from the polygon mirror 105 in a direction toward the photosensitive drum (vertical direction to the paper face) is mounted inside the frame body 102 to be opposed to the polygon mirror 105. A lens 113 for restricting a spot diameter of the laser beam 106b reflected from the polygon mirror 105 is mounted between the polygon mirror 105 and the mirror 112. A circuit board 114 is attached in an area of the frame body 102 opposite to the area where the semiconductor laser 106 is mounted. On this circuit board 114, a synchronizing signal detecting circuit (not shown) having a photodiode 115 for detecting a scan start position of the laser beam 106b is packaged. Also, a mirror 116 for reflecting a laser beam 106c reflected from the polygon mirror 105 in a direction toward the photodiode 115 is mounted near one end portion of the mirror 112 which is the scan start position of the laser beam 106b. A laser beam 106d reflected from the mirror 116 is incident upon the photodiode 115, whereby the scan start position of the laser beam 106b is detected.

However, the conventional laser scanning unit 101 as shown in FIG. 6 had a disadvantage that the kinds of circuit boards are increased, because the motor drive circuit, the semiconductor laser drive circuit and the synchronizing signal detecting circuit are packaged on the circuit boards 121, 122 and 114, respectively, as described above. Also, there was another disadvantage that the iron circuit board 121 on which the motor drive circuit is packaged and the motor 104 is mounted has the heat radiation function and therefore is more expensive than the non-iron circuit board without heat radiation function. As a result, there was a problem that it was difficult to reduce the manufacturing cost of the circuit board.

Thus, some image forming apparatuses having a laser scanning -unit in which a plurality of circuits are packaged on one circuit board were proposed (e.g., refer to JP-A-1-282516 and JP-A-5-110772). In JP-A-1-282516, a laser scanning unit 1 having a semiconductor laser drive circuit and a synchronizing signal detecting circuit packaged on one circuit board was disclosed. In JP-A-5-110772, a laser scanning unit having a semiconductor laser drive circuit and a motor drive circuit packaged on one circuit board was disclosed.

However, in the laser scanning unit as disclosed in JP-A-1-282516, the semiconductor laser is mounted on the circuit board having an increased area due to packaging of the semiconductor laser drive circuit and the synchronizing signal detecting circuit. Therefore, when the semiconductor laser is angularly adjusted, it is required to finely adjust the mounting position of the circuit board having the increased area, resulting in a disadvantage that the angle of the semiconductor laser is difficult to adjust even though the kinds of circuit boards are reduced.

Also, in the laser scanning unit as disclosed in JP-A-5-110772, the motor is mounted on the circuit board having the semiconductor laser drive circuit and the motor drive circuit packaged, whereby the iron circuit board having the heat radiation function is required. Therefore, there is a disadvantage that it is difficult to reduce the manufacturing cost of the circuit board even though the kinds of circuit boards are reduced.

### SUMMARY OF THE INVENTION

This invention has been achieved to solve the above-mentioned problems, and it is an object of the invention to provide a laser printer (image forming apparatus) in which the kinds of circuit boards are reduced and the manufacturing cost of the circuit board is reduced by employing a circuit board without heat radiation function.

It is another object of the invention to facilitate the angular adjustment of a semiconductor laser in the laser printer.

In order to accomplish the above object, according to a first aspect of the invention, there is provided a laser printer having a laser scanning unit, wherein the laser scanning unit includes: a frame body; a semiconductor laser for emitting a laser beam, the semiconductor laser being installed inside the frame body; a semiconductor laser drive circuit for controlling the driving of the semiconductor laser; a polygon mirror for causing the laser beam to scan on a photosensitive drum; a motor for rotating the polygon mirror, the motor being placed inside the frame body and having the polygon mirror mounted; a motor drive circuit for controlling the driving of the motor; a synchronizing signal detecting circuit having a photodiode for detecting a scan start position of the laser beam; and a first circuit board on which the synchronizing signal detecting circuit is packaged; one second circuit board made of paper phenol without heat radiation function for packaging two circuits of the semiconductor laser drive circuit and the motor drive circuit, the second circuit board being provided outside the frame body; a motor mounting member only having a motor mounting function; a first flexible cable for connecting the second circuit board provided outside the frame body and the motor placed inside the frame body; and a second flexible cable for connecting the second circuit board provided outside the frame body and the semiconductor laser installed inside the frame body; wherein the semiconductor laser is mounted inside the frame body to be angularly adjustable by itself; and wherein the motor is mounted inside the frame body via the motor mounting member.

In this configuration, the motor is mounted inside the frame body via the motor mounting member, and two circuits of the semiconductor laser drive circuit and the motor drive circuit are packaged on one second circuit board, as described above, whereby there is no need for employing two circuit boards for the semiconductor laser drive circuit and the motor drive circuit, and the kinds of circuit boards are reduced. As a result, the manufacturing cost of the circuit board is reduced. Also, since the second circuit board is provided outside the frame body, the motor placed inside the frame body is separated from the second circuit board having the semiconductor laser drive circuit and the motor drive circuit packaged, so that heat produced by driving the motor is prevented from conducting to the second circuit board. Thereby, the semiconductor laser drive circuit and the motor drive circuit are protected from breakage due to heat. In this case, the second circuit board made of paper phenol without heat radiation function may be employed. Since the second circuit board made of paper phenol is cheaper than the iron circuit board with heat radiation function, the manufacturing cost of the circuit board is reduced. Also, the manufacturing cost of the motor mounting member is reduced by employing the motor mounting member having the motor mounting function alone.

Also, the semiconductor laser is mounted inside the frame body to be angularly adjustable by itself, whereby the semiconductor laser is angularly adjusted more easily than the semiconductor laser mounted on the circuit board for the semiconductor laser drive circuit.

Also, the motor and semiconductor laser mounted inside the frame body are connected to the second circuit board provided outside the frame body by the first and second flexible cables, respectively, whereby plural wirings are connected at the same time to the second circuit board by the first and second flexible cables composed of a plurality of wires, easily connecting the motor and the semiconductor laser with the second circuit board.

According to a second aspect of the invention, there is provided an image forming apparatus having a laser scanning unit, wherein the laser scanning unit includes: a frame body; a semiconductor laser for emitting a laser beam, the semiconductor laser being installed inside the frame body; a polygon mirror for causing the laser beam to scan on a photosensitive drum; a motor for rotating the polygon mirror, the motor being placed inside the frame body and having the polygon mirror mounted; and a circuit board for packaging two circuits of a semiconductor laser drive circuit for controlling the driving of the semiconductor laser and a motor drive circuit for controlling the driving of the motor, the circuit board being provided in an area a predetermined distance apart from an area where the motor is placed in the frame body.

In this configuration, the motor is mounted inside the frame body, and two circuits of the semiconductor laser drive circuit and the motor drive circuit are packaged on one second circuit board, as described above, whereby there is no need for employing two circuit boards for the semiconductor laser drive circuit and the motor drive circuit, and the kinds of circuit boards are reduced. As a result, the manufacturing cost of the circuit board is reduced. Also, since the circuit board is provided in an area of the frame body a predetermined distance apart from the area where the motor is placed, the motor placed inside the frame body is separated from the circuit board having the semiconductor laser drive circuit and the motor drive circuit packaged, so that heat produced by driving the motor is prevented from conducting to the circuit board. Thereby, the semiconductor laser drive circuit and the motor drive circuit are protected from breakage due to heat.

In the image forming apparatus, the circuit board may include a circuit board made of paper phenol without heat radiation function. With this constitution, since the circuit board made of paper phenol is cheaper than the iron circuit board with heat radiation function, the manufacturing cost of the circuit board is reduced.

The image forming apparatus may further include a motor mounting member having a motor mounting function alone, wherein the motor is mounted inside the frame body via the motor mounting member. With this constitution, the manufacturing cost of the motor mounting member is reduced.

In the image forming apparatus, the semiconductor laser may be mounted inside the frame body to be angularly adjustable by itself. With this constitution, the semiconductor laser is angularly adjusted more easily than the semiconductor laser mounted on the circuit board for the semiconductor laser drive circuit.

The image forming apparatus may further include a first flexible cable for connecting the circuit board provided outside the frame body and the motor placed inside the frame body, and a second flexible cable for connecting the circuit board provided outside the frame body and the semiconductor laser installed inside the frame body. With this constitution, plural wirings are connected at the same time to the circuit board by the first and second flexible cables composed of a plurality of wires, easily connecting the motor and the semiconductor laser with the second circuit board.

### BRIEF DESCRIPTION OF THE DRAWINGS

FIG. 1 is a perspective view showing a laser printer according to one embodiment of the present invention;

FIG. 2 is a plan view showing an internal structure of a laser scanning unit in the laser printer according to one embodiment as shown in FIG. 1;

FIG. 3 is a cross-sectional view of the laser scanning unit according to one embodiment as shown in FIG. 2, taken along line III-III;

FIG. 4 is a plan view of a circuit board for the laser scanning unit according to one embodiment as shown in FIG. 2;

FIG. 5 is a perspective view of a conventional laser printer; and

FIG. 6 is a plan view showing an internal structure of a laser scanning unit in the conventional laser printer as shown in FIG. 5.

### DETAILED DESCRIPTION OF THE PREFFERED EMBODIMENTS

The preferred embodiments of the present invention will be described below with reference to the accompanying drawings.

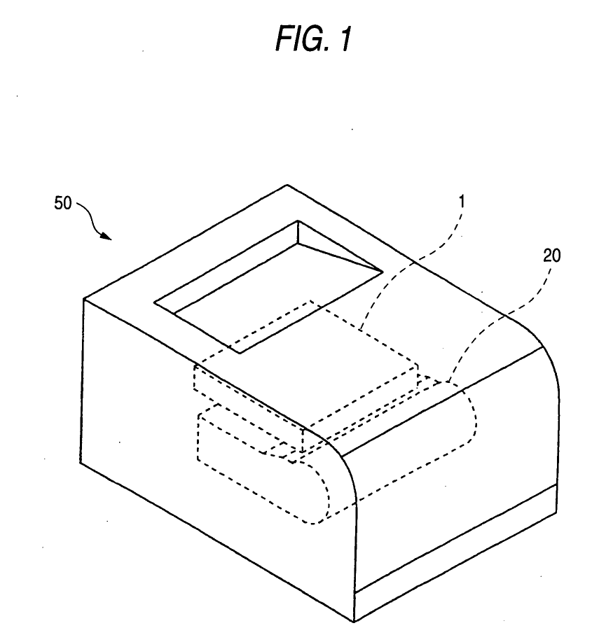

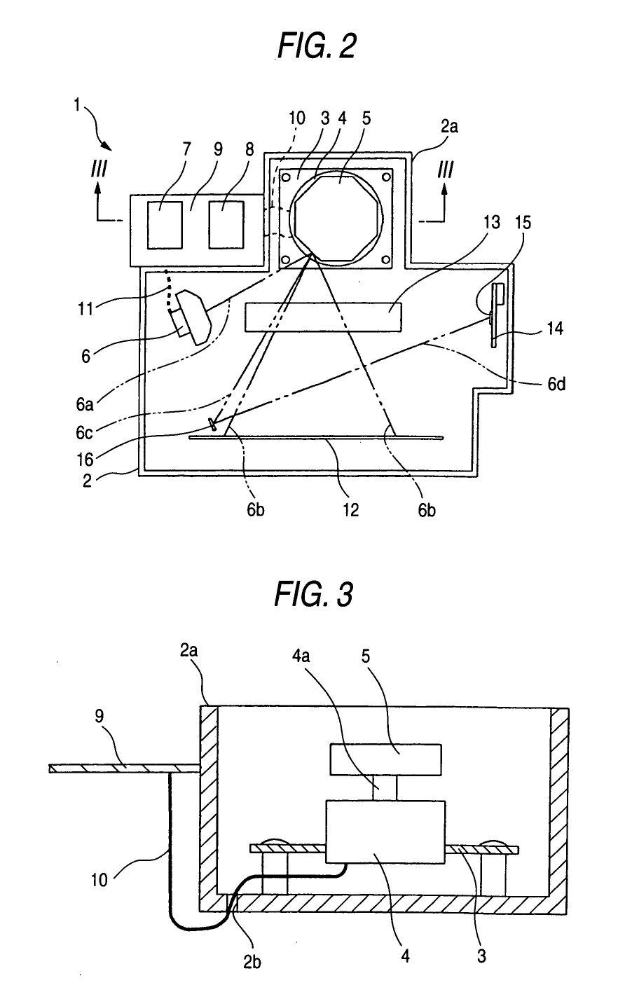

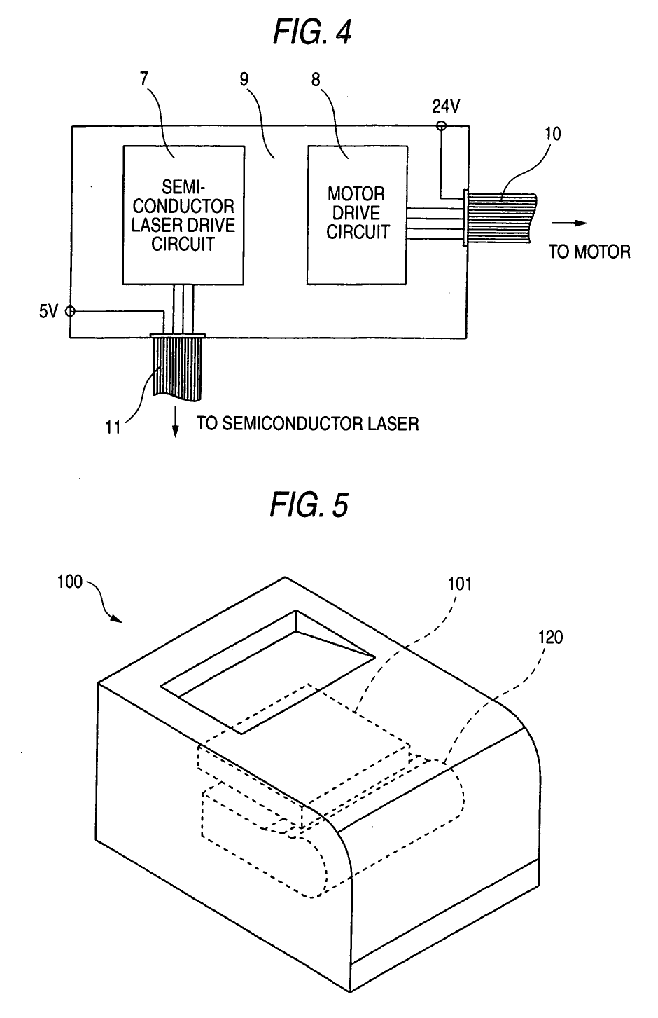

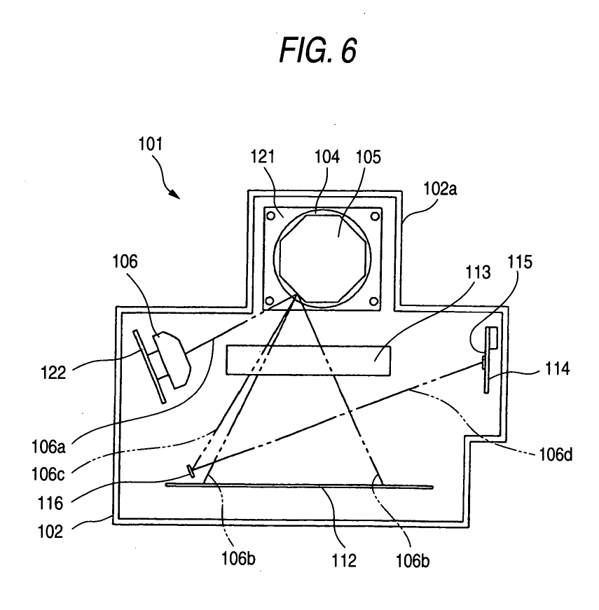

FIG. 1 is a perspective view showing a laser printer according to one embodiment of the present invention. FIG. 2 is a plan view showing an internal structure of a laser scanning unit in the laser printer according to one embodiment as shown in FIG. 1. FIG. 3 is a cross-sectional view of the laser scanning unit according to one embodiment as shown in FIG. 2, taken along line III-III. FIG. 4 is a plan view of a circuit board for the laser scanning unit according to one embodiment as shown in FIG. 2. First of all, reference to FIGS. 1 to 4 is made to describe the structure of the laser printer according to the embodiment.

A laser printer 50 according to this embodiment has a toner cartridge 20 and a laser scanning unit 1, as shown in FIG. 1. The toner cartridge 20 is provided with a photosensitive drum (not shown) for transferring toner onto a paper and a toner tank portion (not shown) filled with toner. The laser scanning unit 1 has various parts installed to form an electronic image on the photosensitive drum.

More specifically, a motor 4 is mounted via a motor mounting member 3 only having a motor mounting function inside a convex portion 2a provided on a frame body 2, as shown in FIGS. 2 and 3. A polygon mirror 5 for causing a laser beam 6b to scan on the photosensitive drum by reflecting a laser beam 6a while rotating is mounted on a rotation shaft 4a of the motor 4. Also, a semiconductor laser 6 is mounted in a predetermined area inside the frame body 2 to be able to emit the laser beam 6a in a direction toward the polygon mirror 5 and adjust the angle by itself.

In this embodiment, two circuits of a semiconductor laser drive circuit 7 for controlling the driving of the semiconductor laser 6 and a motor drive circuit 8 for controlling the driving of the motor 4 are packaged on one circuit board 9 made of paper phenol without heat radiation function that is provided outside the frame body 2, as shown in FIG. 2. The circuit board 9 is an example of “a second circuit board” of the invention. The circuit board 9 provided outside the frame body 2 and the motor 4 mounted inside the convex portion 2a of the frame body 2 are connected through a hole portion 2b provided in the frame body 2 by a flexible cable 10 composed of five wires, as shown in FIG. 3. The flexible cable 10 is an example of “a first flexible cable”. This flexible cable 10 connects five wires including a voltage (24V) supply conductor, a grounding conductor and a Hall element signal conductor, as shown in FIG. 4.

The circuit board 9 provided outside the frame body 2 and the semiconductor laser 6 mounted inside the frame body 2 are connected via a hole portion (not shown) provided in the frame body 2 by a flexible cable 11 composed of three wires, as shown in FIG. 2. The flexible cable 11 is an example of “a second flexible cable”. This flexible cable 11 connects three wires including a voltage (5V) supply conductor, an on/off control signal conductor and a photodiode signal conductor, as shown in FIG. 4.

A mirror 12 for reflecting the laser beam 6b reflected from the polygon mirror 5 in a direction toward the photosensitive drum (vertical direction to the paper face) is mounted inside the frame body 2 to be opposed to the polygon mirror 5, as shown in FIG. 2. A lens 13 for restricting a spot diameter of the laser beam 6b reflected from the polygon mirror 5 is mounted between the polygon mirror 5 and the mirror 12. A circuit board 114 is attached in an area of the frame body 2 opposite to the area where the semiconductor laser 6 is mounted. The circuit board 14 is an example of “a first circuitboard” of the invention. On this circuit board 14, a synchronizing signal detecting circuit (not shown) having a photodiode 15 for detecting a scan start position of the laser beam 6b is packaged. Also, a mirror 16 for reflecting a laser beam 6c reflected from the polygon mirror 5 to a direction toward the photodiode 15 is mounted near one end portion of the mirror 12 which is the scan start position of the laser beam 6b. A laser beam 6d reflected from the mirror 16 is incident upon the photodiode 15 to detect the scan start position of the laser beam 6b.

In this embodiment, the motor 4 is mounted inside the convex portion 2a of the frame body 2 via the motor mounting member 3, and two circuits of the semiconductor laser drive circuit 7 and the motor drive circuit 8 are packaged on one circuit board 9, whereby there is no need for employing two circuit boards for the semiconductor laser drive circuit and the motor drive circuit, making it possible to reduce the kinds of circuit boards. As a result, the manufacturing cost of the circuit board is reduced. Since the circuit board 9 is provided outside the frame body 2, the motor 4 mounted inside the frame body 2 is separated from the circuit board 9 having the semiconductor laser drive circuit 7 and the motor drive circuit 8 packaged, preventing heat produced by driving the motor 4 from being conducted through the circuit board 9. Thereby, the semiconductor laser drive circuit 7 and the motor drive circuit 8 are protected from breakage due to heat of the motor 4. In this case, the circuit board 9 made of paper phenol without heat radiation function may be employed. Because this circuit board 9 made of paper phenol is less expensive than the iron circuit board with heat radiation function, the manufacturing cost of the circuit board 9 is reduced. Also, the manufacturing cost of the motor mounting member 3 is reduced by employing the motor mounting member 3 with motor mounting function alone.

In this embodiment, the semiconductor laser 6 is mounted inside the frame body 2 to be able to adjust the angle of the semiconductor laser 6 by itself, whereby the semiconductor laser 6 is angularly adjusted more easily than the semiconductor laser mounted on the circuit board for the semiconductor laser drive circuit.

In this embodiment, the motor 4 and the semiconductor laser 6 mounted inside the frame body 2 are connected to the circuit board 9 provided outside the frame body 2 by the flexible cables 10 and 11, respectively, whereby a plurality of conductors are connected to the circuit board 9 by the flexible cables 10 and 11 composed of plural wires at the same time, easily connecting the motor 4 and the semiconductor laser 6 with the circuit board 9.

Referring to FIG. 2, the operation of the laser scanning unit according to one embodiment will be described below. First of all, a laser beam 6a emitted from the semiconductor laser 6 is reflected in a direction toward the mirror 12 by the polygon mirror 5. A laser beam 6b reflected from the polygon mirror 5 is reflected in a direction toward the photosensitive drum by the mirror 12, with its spot diameter restricted by the lens 13. Thereby, the laser beam 6b is scanned on the electrified photosensitive drum, while electric charges are extinguished in a scanned portion alone on the electrified photosensitive drum by the laser beam 6b. In this case, the rotation of the polygon mirror 5 is controlled by driving the motor 4, and the laser beam 6b is caused to scan in a predetermined region on the photosensitive drum by controlling the driving of the semiconductor laser 6. Also, the scan start position of the laser beam 6b is detected by causing a laser beam 6d reflected from the mirror 16 to enter the photodiode 15.

Thereby, since the laser beam 6d is caused to scan in a predetermined region alone on the photosensitive drum, a given electronic image is formed on the photosensitive drum. Thereafter, toner is attached onto a portion on the photosensitive drum where electric charges are extinguished. And the image is formed on the paper by transferring toner attached on the photosensitive drum to the paper.

The embodiment as disclosed above is only exemplary in all respects but not limitative. The invention is limited by the scope as defined in the claims, but not the description of the embodiments, and all the variations may be included within the scope or spirit of the claims.

For example, the invention is applied to the laser scanning unit of the laser printer in the above embodiment. However, the invention is not limited thereto, and may be applied to the laser scanning unit of the image forming apparatus other than the laser printer.

Also, the circuit board 9 having the semiconductor laser drive circuit 7 and the motor drive circuit 8 packaged is provided outside the frame body 2 in the above embodiment. However, this invention is not limited thereto, and they may be provided inside the frame body 2 a predetermined distance apart from the convex portion 2a of the frame body 2 where the motor 4 is mounted to achieve the same effect as in the above embodiment.

Also, the circuit board 9 made of paper phenol without heat radiation function is employed in the above embodiment. However, this invention is not limited thereto, and the circuit board made of other materials without heat radiation function may be employed.

Also, the motor 4 and the semiconductor laser 6 mounted inside the frame body 2 are connected via the flexible cables 10 and 11 to the circuit board 9 provided outside the frame body 2 in the above embodiment. However, this invention is not limited thereto, and the motor and the semiconductor laser may be connected to the circuit board, employing other wiring means.

As described above, with this invention, a laser printer (image forming apparatus) can be provided in which the kinds of circuit boards are reduced and the manufacturing cost of the circuit board is reduced by employing the circuit board without heat radiation function.

What is claimed is:

1. A laser printer comprising a laser scanning unit,
wherein the laser scanning unit comprises:
a frame body;
a semiconductor laser for emitting a laser beam, the semiconductor laser being installed inside the frame body;
a semiconductor laser drive circuit for controlling the driving of the semiconductor laser;
a polygon mirror for causing the laser beam to scan on a photosensitive drum;
a motor for rotating the polygon mirror, the motor being placed inside the frame body and having the polygon mirror mounted;
a motor drive circuit for controlling the driving of the motor;
a synchronizing signal detecting circuit having a photodiode for detecting a scan start position of the laser beam; and
a first circuit board on which the synchronizing signal detecting circuit is packaged;
one second circuit board made of paper phenol without heat radiation function for packaging two circuits of the semiconductor laser drive circuit and the motor drive circuit, the second circuit board being provided outside the frame body;
a motor mounting member only having a motor mounting function;
a first flexible cable for connecting the second circuit board provided outside the frame body and the motor placed inside the frame body; and
a second flexible cable for connecting the second circuit board provided outside the frame body and the semiconductor laser installed inside the frame body;
wherein the semiconductor laser is mounted inside the frame body to be angularly adjustable by itself; and
wherein the motor is mounted inside the frame body via the motor mounting member.

2. An image forming apparatus comprising a laser scanning unit, wherein the laser scanning unit comprises:
a frame body;
a semiconductor laser for emitting a laser beam, the semiconductor laser being installed inside the frame body;
a polygon mirror for causing the laser beam to scan on a photosensitive drum;
a motor for rotating the polygon mirror, the motor being placed inside the frame body and having the polygon mirror mounted; and
a circuit board for packaging two circuits of a semiconductor laser drive circuit for controlling the driving of the semiconductor laser and a motor drive circuit for controlling the driving of the motor, the circuit board being provided in an area a predetermined distance apart from an area where the motor is placed in the frame body.

3. The image forming apparatus according to claim 2, wherein the circuit board comprises a circuit board made of paper phenol without heat radiation function.

4. The image forming apparatus according to claim 2, further comprising a motor mounting member only having a motor mounting function, wherein the motor is mounted inside the frame body via the motor mounting member.

5. The image forming apparatus according to claim 2, wherein the semiconductor laser is mounted inside the frame body to be angularly adjustable by itself.

6. The image forming apparatus according to claim 2, further comprising:
a first flexible cable for connecting the circuit board provided outside the frame body and the motor placed inside the frame body; and
a second flexible cable for connecting the circuit board provided outside the frame body and the semiconductor laser installed inside the frame body.
